(19) United States
(12) Patent Application Publication
(10) Pub. No.: US 2008/0028166 A1
(43) Pub. Date: Jan. 31, 2008

(54) DATA PROCESSING SYSTEM AND METHOD FOR OPERATING A DATA PROCESSING SYSTEM

(75) Inventors: Oliver Kniffler, Munich (DE); Michael Smola, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/609,246

(22) Filed: Dec. 11, 2006

(30) Foreign Application Priority Data
Jul. 28, 2006 (DE) 10 2006 035 039.1

(51) Int. Cl. G06F 13/00

(52) U.S. Cl. 711/154

(57) ABSTRACT

A data processing method and system including a processor, a user data storage medium, and a management data storage medium, wherein the management data are used to manage the user data.

### CROSS-REFERENCE TO RELATED APPLICATION

This application claims priority to German Patent Application Serial No. 10 2006 035 039.1, filed Jul. 28, 2006, and which is incorporated herein by reference in its entirety.

### FIELD OF THE INVENTION

The invention relates to a data processing system having a processor and a first storage medium and to a method for operating a data processing system having a processor and a user data memory.

### BACKGROUND OF THE INVENTION

Data processing systems generally include a data processing unit, which is also referred to as a processor, and at least one memory, which is connected to the processor via a bus. Increasingly larger memories are being used in embedded systems, microcontrollers and chip cards in order to be able to store larger volumes of data. Removable storage media, for example a multimedia card, an SD card or compact flash, or, as in the case of a chip card, memory modules which are permanently integrated in the system may be used as memories in this case.

A file system is needed to manage the data in these memories since, from the point of view of the operating system, data can be read or written only as entire blocks which usually comprise 512 bytes. A plurality of blocks, typically four or eight, are combined to form a cluster. Each file occupies one or more clusters. There are many ways of allocating the clusters to the file. One of the possibilities is to store a file allocation table in the memory. The so-called FAT (File Allocation Table) file system in which the file allocation table is a concatenated list containing information on each cluster is very widespread. This information can be used to determine whether a cluster has not been occupied because it is free, for example, or because the memory is damaged at this position, or whether the cluster has been occupied by a file. If the cluster has been occupied by a file, the information contains the number of the next cluster of the file or the indication that this is the last cluster of the file. These management data are typically stored in the same way as normal user data on the storage medium at predefined addresses or in predefined groups of data blocks. In order to be able to access a file that is stored on the storage medium, it is necessary to access the management data one or more times in order to determine the clusters of data blocks associated with the file and to read them out in the correct order.

In the data processing system described above the management data and the user data are accessed using the same physical channel which leads to the storage medium. This reduces the transfer rate at which the user data can be read out or written. This is disadvantageous, in particular, for systems in which a file can occupy a large number of clusters since it is necessary to access the file allocation table for each cluster in order to determine the respective next cluster in the chain of clusters in which the file is stored.

In order to increase the transfer rate, use may be made of a cache in order to buffer-store the file to be transmitted in a local memory which is typically a RAM memory. However, only inefficient use of the cache is possible on account of the fact that the user data and management data constantly change. As a remedy, a respective separate cache can be provided for the management data and for the user data so that data are not mutually displaced. However, it requires a greater amount of RAM memory.

### BRIEF DESCRIPTION OF THE DRAWING

The invention will be explained in more detail below using exemplary embodiments and with reference to a drawing.

### DESCRIPTION OF THE INVENTION

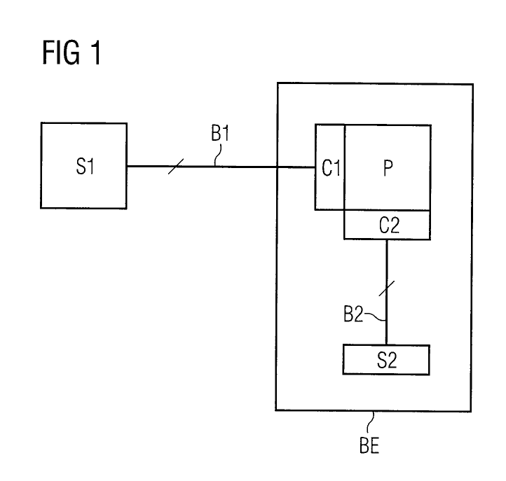

FIG. 1 shows an embodiment of a data processing system having a processor P, a first storage medium S1 and a second storage medium S2. The processor P has a first cache C1 and a second cache C2. The first storage medium S1 is connected to a first cache C1 via a first bus B1 and the second storage medium S2 is connected to a second cache C2 via a second bus B2.

The first storage medium S1 is used to store user data and may be in the form of a serial nonvolatile NAND flash memory. It may also be a removable storage medium, for example a multimedia card, an SD card, a compact flash card, or any other similar memory. The user data which are stored on the first storage medium S1 are managed using a file system having file allocation tables, for example a FAT file system.

In this exemplary embodiment, the management data comprise the file allocation tables and are stored on the second storage medium S2. In order to access the user data on the first storage medium S1, the processor P first of all accesses the management data on the second storage medium S2 via the second bus B2. The processor P then uses the information on the allocation of the clusters to the user data to access the corresponding user data via the first bus B1. The processor P can use the management data to determine the sequence of clusters so that the user data can then be accessed without interruption. In this case, the processor P can access the first storage medium S1 and the second storage medium S2 simultaneously.

The corresponding data may be buffer-stored in the first cache C1 and the second cache C2 in order to allow data to be processed efficiently. Since separate buses B1 and B2 and separate caches C1 and C2 are provided for the management data and the user data, the data throughput when accessing the user data can be increased.

The second storage medium S2 can be integrated with the processor P and the second bus B2 in a component BE and may be a nonvolatile memory, for example an EEPROM or other similar memory. In comparison with the first storage medium S1 which is designed for the inexpensive storage of large volumes of data, the second storage medium S2 has short access times and a low power consumption. The management data which are stored on the second storage medium S2 are particularly well protected against being spied out or manipulated if the component BE is a security controller. Access to the management data is then possible only via the processor within the component BE and is additionally protected using the security mechanisms in the security controller. Alternatively, the second storage medium S2 may also be an external memory which is inseparably connected to the processor P.

The first storage medium S1 and the second storage medium S2 are in the form of nonvolatile memories. It goes without saying that the invention can also be implemented using volatile memories as long as they are supplied with the power required for storage or the data need to be stored only for a short time.

In an alternative design, the first storage medium S1 and the second storage medium S2 may be connected to the processor P via a joint bus. The protection against spying out or manipulation is somewhat reduced as a result since, in the case of a removable first storage medium S1, it is also possible to access the joint bus which is used to transmit the management data from the second storage medium.

The protection against the user data being spied out or manipulated can be further increased by storing the data in encrypted form on the first storage medium S1. In particular, as a result of the integrated design of the component BE, it is not possible to access the data stored on the second storage medium S2 except via the processor P.

Without the management data which are stored on the second storage medium S2, it is not possible to meaningfully access the user data which are stored on the first storage medium S1. The user data can thus be used only in a data processing system having the associated management data. Conversely, the functionality of the data processing system can be greatly restricted by removing the user data memory.

By providing a separate storage medium for the management data, the invention makes it possible to increase the protection against user data, which are stored on the first storage medium, being spied out and manipulated. If the second storage medium is also connected to the processor P via its own bus, the data throughput when accessing the user data can be increased.

The data processing system shown can be used, in particular, in embedded systems, for example microcontrollers or chip cards.

The first storage medium is connected to the processor via a bus and the second storage medium is connected to the processor via a further bus. As a result of the fact that each storage medium is connected to the processor via its own bus, the operations of accessing the user data and the management data can be optimized. For example, the processor can access the user data and the management data in a parallel manner and can thus increase the data throughput of the data processing system. However, the first storage medium and the second storage medium may also be connected to the processor via a joint bus. This has the advantage that the chip area required for the data processing system is reduced.

The processor has a first cache for buffer-storing the user data which are transmitted via the first bus.

The processor has a second cache for buffer-storing the management data which are transmitted via the second bus. The use of caches makes it possible to increase the data throughput. If a separate cache is also provided for each of the buses, the user data and management data are not mutually displaced.

The management data are file allocation tables. The file allocation tables which are stored on the second storage medium indicate how a file is stored in the clusters of the first storage medium. If the management data or file allocation tables are unknown, it is not possible to utilize the user data on the first storage medium in a meaningful manner. The user data can be protected against being spied out or manipulated by separately storing the management data and user data.

The second storage medium and the processor are inseparably connected to one another. The management data which are stored on the second storage medium are thus physically tied to the processor. As a result of the fact that the second storage medium comprises the management data for the user data stored on the first storage medium, it is thus also possible to couple the first storage medium to the processor. The user data which are stored on the first storage medium can thus be used only in precisely one system, with the result that it is possible to prevent them from being copied or modified by another processor.

The second storage medium and the processor are integrated in a component.

As a result of the fact that the processor and the second storage medium are integrated in a component, it is possible, in comparison with the external storage media, to use fast and power-saving second storage media. The management data are thus accessed at high speed and with a low power requirement. This is advantageous in battery-operated data processing systems, in particular.

The processor is a security controller. Security controllers have special protective measures which protect the design of the processor and data stored in the latter. If the second storage medium is integrated together with the processor in a security controller, the management data are stored and processed completely inside the security controller, thus making it more difficult to manipulate or spy out the management data and thus the user data as well.

The first storage medium can be removed from the data processing system. Since the user data on the first storage medium can be meaningfully interpreted only with the aid of the management data on the second storage medium, the user data are protected against being spied out or manipulated by separating the first storage medium from the second storage medium. Use of the data processing system without the first storage medium can also be restricted.

The first storage medium and the second storage medium are nonvolatile memories. The use of nonvolatile memories makes it possible for the user data, which are stored on the first storage medium, and for the management data, which are stored on the second storage medium, to be retained even without a power supply. On account of the large volumes of data, NAND flash memories, as are used in multimedia cards, SD cards or compact flash cards, are advantageous, in particular, for the first storage medium since they have a high storage density. Storage media having short access times and a low power consumption such as flash memories or EEPROM memories may be advantageously used for the second storage medium.

The management data and the user data are stored in a nonvolatile manner.

The management data can be accessed only via the processor. The management data memory may, for example, be part of a security controller, so that the storage and processing of the management data are protected against attacks using the security mechanisms in the security controller. Since it is not possible to access the management data in any other way, it is not possible to access the user data in a meaningful manner either.

The processor accesses the user data via a bus and accesses the management data via a further bus. The separate buses for the user data and the management data make it possible to increase the data throughput since they are not addressed using the same physical channel. Furthermore, a separate cache can be used for each bus so that the user data and management data are not constantly changed in a joint cache.

The data in the user data memory are stored in encrypted form. Encryption further increases the protection against security-relevant user data from the user data memory being spied out or manipulated. In addition, encrypting the user data makes it considerably more difficult to reconstruct the management data from the user data.

After the user data have been stored in the user data memory and the associated management data have been stored in the management data memory, the user data memory is removed from the data processing system. Separating the user data from the associated management data makes it possible, on the one hand, to protect the user data against being spied out since the requisite management data are unknown and, on the other hand, the data processing system can no longer be operated in a meaningful manner without the user data memory.

What is claimed is:

1. A data processing system, comprising:
a processor;
a first storage medium with user data stored thereon; and
a second storage medium with management data, which are used to manage the user data, stored thereon.

2. The data processing system of claim 1, wherein the first storage medium is connected to the processor via a first bus and the second storage medium is connected to the processor via a second bus.

3. The data processing system of claim 1, wherein the first storage medium and the second storage medium are connected to the processor via a joint bus.

4. The data processing system of claim 1, wherein the data are stored in the user data memory in encrypted form.

5. The data processing system of claim 2, wherein the processor has a first cache for buffer-storing the user data which have been transmitted via the first bus.

6. The data processing system of claim 2, wherein the processor has a second cache for buffer-storing the management data which have been transmitted via the second bus.

7. The data processing system of claim 1, wherein the management data are file allocation tables.

8. The data processing system of claim 1, wherein the second storage medium and the processor are inseparably connected to one another.

9. The data processing system of claim 1, wherein the second storage medium and the processor are integrated in a component.

10. The data processing system of claim 1, wherein the processor is a security controller.

11. The data processing system of claim 1, wherein the first storage medium can be removed from the data processing system.

12. The data processing system of claim 1, wherein the first storage medium and the second storage medium are nonvolatile memories.

13. The data processing system of claim 1, wherein the first storage medium and the second storage medium are volatile memories.

14. The data processing system of claim 1, wherein the user data are managed using a file system having file allocation tables.

15. The use of a data processing system of claim 1 in a chip card, a microcontroller, or an embedded system.

16. A method for operating a data processing system having a processor, the method comprising:
storing user data in a user data memory;
storing management data, which are used to manage the user data, in a management data memory which is physically separated from the user data memory.

17. The method of claim 16, wherein the management data and the user data are stored in a nonvolatile manner.

18. The method of claim 16, wherein the management data and the user data are stored in a volatile manner.

19. The method of claim 16, wherein the management data can be accessed only via the processor.

20. The method of claim 16, further comprising:
accessing, by the processor, the user data via a first bus; and
accessing, by the processor, the management data via a second bus.

21. The method of claim 16, further comprising accessing, by the processor, the user data and the management data via a joint bus.

22. The method of claim 16, wherein the data are stored in the user data memory in encrypted form.

23. The method of claim 16, further comprising managing the user data using a file system having file allocation tables.

24. The method of claim 16, further comprising, after the user data have been stored in the user data memory and the associated management data have been stored in the management data memory, removing the user data memory from the data processing system.

25. A data processing system, comprising:
a processor;
a first storage means for storing user data; and
a second storage means for storing management data, which are used to manage the user data.

26. A data processing system comprising:
a processor;
a user data storage medium; and
a management data storage medium,
wherein the management data are used to manage the user data.
